(19) United States
(12) Patent Application Publication
(10) Pub. No.: US 2019/0340935 A1
(43) Pub. Date: Nov. 7, 2019

(54) AIRCRAFT NAVIGATION SYSTEM FOR FREE ROUTE AIRSPACE

(71) Applicant: HONEYWELL INTERNATIONAL INC., Morris Plains, NJ (US)

(72) Inventors: Prabhudev Bhuyar, Bangalore (IN); Jeevish Glastine Gurumoorthi, Bangalore (IN); Vanshikrishna Adhikarla, Bangalore (IN)

(73) Assignee: HONEYWELL INTERNATIONAL INC., Morris Plains, NJ (US)

(21) Appl. No.: 15/969,966

(22) Filed: May 3, 2018

(51) Int. Cl. G08G 5/00

(52) U.S. Cl. CPC G08G 5/006; G08G 5/0039; G08G 5/0021

(57) ABSTRACT

Systems and methods are provided for displaying an availability for free routing within at least one free route airspace location to a pilot. The method includes the step of storing information related to at least one free route airspace location along a flight plan of the aircraft and an associated time window of availability for free routing within the at least one free route airspace locations in a memory module. The method also includes the step of comparing the stored time window of availability for free routing within the at least one free route airspace location to a system clock time. The method also includes the step of determining, on the basis of the comparison, the present availability for free routing within the at least one free route airspace location. The method also includes the step of displaying the present availability for free routing within the at least one free route airspace location to the pilot.

### TECHNICAL FIELD

The present disclosure generally relates to the field of navigation systems. More particularly, the present disclosure relates to aircraft navigation systems.

### BACKGROUND

In recent years, the concept of free route airspace (FRA) has become more prevalent in aviation. More than 30 European countries have already begun implementing free route airspace, and it is envisaged that most European countries will have implemented free route airspace (FRA) by the end of 2019.

Free route airspace (FRA) is dedicated airspace within which users of that airspace can freely plan a route between an established entry point into that airspace and an established exit point from that airspace, instead of following fixed routes within the airspace. The freely planned route between the established entry point and established exit point may route via predetermined intermediate waypoints, according to the flight plan of the user. Although the route between the established entry point and the established exit point may be freely planned by the user, the aircraft in the free route airspace remains subject to air traffic control.

It is envisaged that the introduction of free route airspace will allow aviation travel to become more efficient. In particular, by allowing users of the free route airspace the freedom to choose their own routes within this airspace instead of restricting aircraft to particular predefined fixed routes, shorter and more fuel-efficient routes may be established by the airspace users.

During the implementation period of free route airspace (FRA), it has been deemed necessary by airspace authorities to limit free routing in certain airspaces to particular periods of time. In particular, it may be desirable to restrict aircraft operating in a certain airspace to fixed routes during busy periods of that airspace and to allow free routing of aircraft in that airspace at less busy times. This is because free routing of aircraft may have certain disadvantages. More specifically, free routing of aircraft may result in conflicts between aircraft becoming harder to detect due to the increased spread and number of potential conflicts. Free routing of aircraft may also result in conflicts occurring shortly after aircraft have entered an area of air traffic control (ATC) responsibility, which may result in ATC having less time to recognize and resolve these conflicts. Lastly, the lack of fixed routes may increase the risk of responsibility “blind spots”, where it is not apparent if one particular ATC has responsibility. By restricting free routing to less busy time periods, these disadvantages may be reduced or avoided.

This type of time-dependent transitioning between free routing and fixed routing in free route airspace locations may also continue after free route airspace (FRA) procedures have been fully implemented.

Delays or other unexpected occurrences may occur when an aircraft is following a flight plan. When such a delay or other unexpected occurrence occurs, the aircraft may reach a certain airspace at a later or earlier time than originally planned, according to the aircraft's flight plan. If an aircraft reaches a time-dependent free route airspace at an earlier or later time than expected, the pilot's workload may be increased. In particular, the pilot would have to determine, upon reaching the free route airspace, whether free routing was permitted in the free route airspace on the basis of the present time and the time window availability for free routing of the free route airspace, and then determine whether a free route or a fixed route should be followed. In other words, if a flight plan originally intended for a freely planned route to be followed through free route airspace, but a delay caused the aircraft to arrive at the free route airspace at a time period where free routing was not permitted, the pilot may have an increased workload to determine flight plan modifications.

It would therefore be desirable to decrease pilot workload and increase pilot situational awareness in such situations.

### BRIEF SUMMARY

This summary is provided to introduce a selection of concepts in a simplified form that are further described below in the detailed description section.

In an exemplary embodiment, there is provided a navigation system for use in an aircraft. The navigation system includes a display. The navigation system also includes a memory module configured to store information related to at least one free route airspace location along a flight plan of the aircraft and an associated time window of availability for free routing of the at least one free route airspace location. The navigation system also includes a processing module operably connected to the display and to the memory module. The processing module is configured to receive the information related to the at least one free route airspace location and associated time window of availability for free routing from the memory module and to cause the display to display a real-time representation of an availability of free routing within the at least one free route airspace location.

In another exemplary embodiment, there is provided a method of displaying an availability for free routing within at least one free route airspace location to a pilot. The method includes the step of storing information related to at least one free route airspace location along a flight plan of the aircraft and an associated time window of availability for free routing within the at least one free route airspace locations in a memory module. The method also includes the step of comparing the stored time window of availability for free routing within the at least one free route airspace location to a system clock time. The method also includes the step of determining, on the basis of the comparison, the present availability for free routing within the at least one free route airspace location. The method also includes the step of displaying the present availability for free routing within the at least one free route airspace location to the pilot.

Other desirable features will become apparent from the following detailed description and the appended claims, taken in conjunction with the accompanying drawings and this background.

### BRIEF DESCRIPTION OF THE DRAWINGS

A more complete understanding of the subject matter may be derived from the following detailed description taken in conjunction with the accompanying drawings, wherein like reference numerals denote like elements, and wherein:

FIG. 1 shows a schematic of a navigation system in accordance with various embodiments;

FIG. 2 shows a real-time representation of a free route airspace location in accordance with various embodiments

FIG. 3 shows a real-time representation of a free route airspace location in accordance with various embodiments;

FIG. 4 shows a real-time representation of a free route airspace location in accordance with various embodiments;

FIG. 5 shows a real-time representation of a free route airspace location in accordance with various embodiments;

FIG. 6 shows a flowchart of a method in accordance with various embodiments;

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the systems and methods defined by the claims. As used herein, the term “module” refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality. Furthermore, there is no intention to be bound by any expressed or implied theory presented in the preceding Technical Field, Background, Brief Summary or the following Detailed Description.

For the sake of brevity, conventional techniques and components may not be described in detail herein. Furthermore, any connecting lines shown in the various figures contained herein are intended to represent example functional relationships and/or physical couplings between the various elements. It should be noted that many alternative or additional functional relationships or physical connections may be present in an embodiment of the present disclosure.

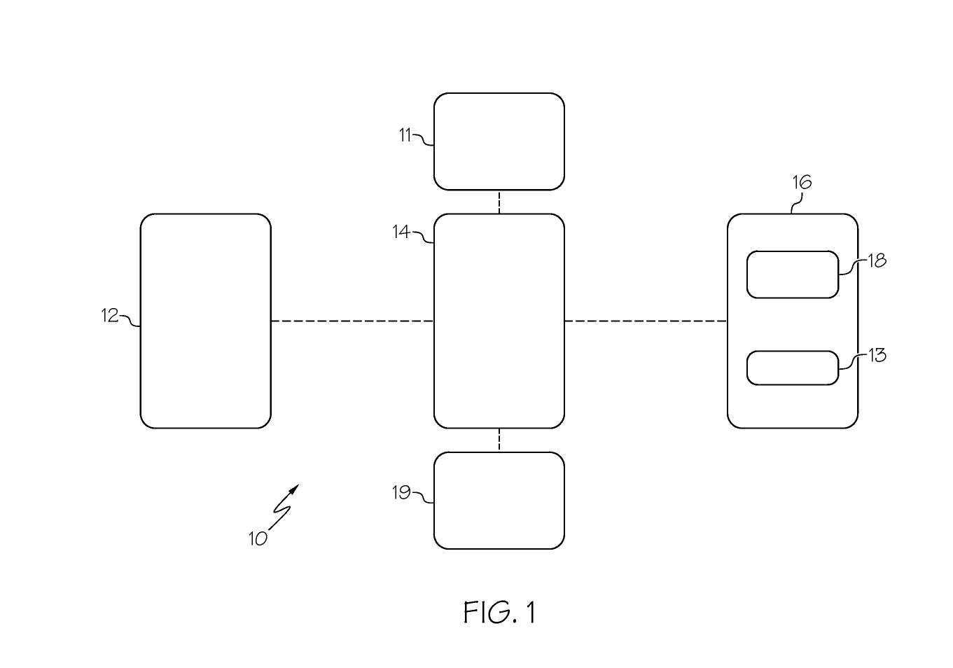

FIG. 1 shows a schematic of a navigation system 10 for an aircraft in accordance with various embodiments. The navigation system 10 includes a memory module 12. The memory module 12 stores information relating to free route airspace (FRA) locations with respect to a predetermined flight plan of the aircraft. The memory module 12 also stores information relating to associated time windows of free routing availability of the free route airspace locations. As used herein, the term “time windows of free routing availability” defines the periods of time where free routing of the aircraft is permitted in the free route airspace locations. Outside of the time windows of free routing availability, free routing of the aircraft is not permitted in the free route airspace locations, and aircraft within the free route airspace locations at these times must travel along fixed routes. In exemplary embodiments, the memory module 12 also stores information established entry points into free route airspace locations and established exit points from the free route airspace locations. For example, the memory module 12 may store information about established entry points and established exit points to and from free route airspace locations for the aircraft according to a stored flight plan, and also established entry points and established exit points to and from free route airspace locations available for other aircraft.

A processing module 14 is operably connected to the memory module 12. A navigation module 16 is operably connected to the processing module 14. The processing module 14 is configured to receive information relating to the free route airspace locations along the flight plan of the aircraft and the associated time windows of availability for free routing within the free route airspace locations, and to transmit this information to the navigation module 16. In exemplary embodiments, multiple free route airspace locations are present along the flight plan of the aircraft. In various other exemplary embodiments, only one free route airspace location is present along the flight plan of the aircraft. In exemplary embodiments, the information stored in the memory module 12 includes the location of boundaries of the free route airspace locations. In exemplary embodiments, the processing module 14 compares the information relating to the free route airspace location to the aircraft's present location as determined by a positioning module 19 that is operably connected to the processing module 14. In exemplary embodiments, the positioning module 19 includes a GPS system. In exemplary embodiments, the processing module 14 compares the information relating to the time windows of availability of the free route airspace locations to a present time derived from a system clock 11 operably connected to the processing module 14. Based on a comparison of the free route airspace locations relative to the aircraft's present location and on a comparison of the associated time windows of availability of the free route airspace locations to a present time according to the system clock 11, the processing module 14 can select relevant information to transmit to the navigation module 16.

The navigation module 16 includes a display 18 configured to output visual information. In exemplary embodiments, the navigation module 16 additionally includes a speaker 13 configured to output audio information. The navigation module 16 is configured to display a real-time representation to the pilot of the associated time windows of availability of the free route airspace locations along the aircraft's planned flight route. In exemplary embodiments, the navigation module 16 is configured to only display free route airspace locations close to the aircraft's current location, for example within a predetermined distance or within a predetermined flight-time of the aircraft. By displaying only those free route airspace locations that are close to the aircraft's current location, the data presented on the real-time representation can be presented in a clear, uncluttered manner to the pilot.

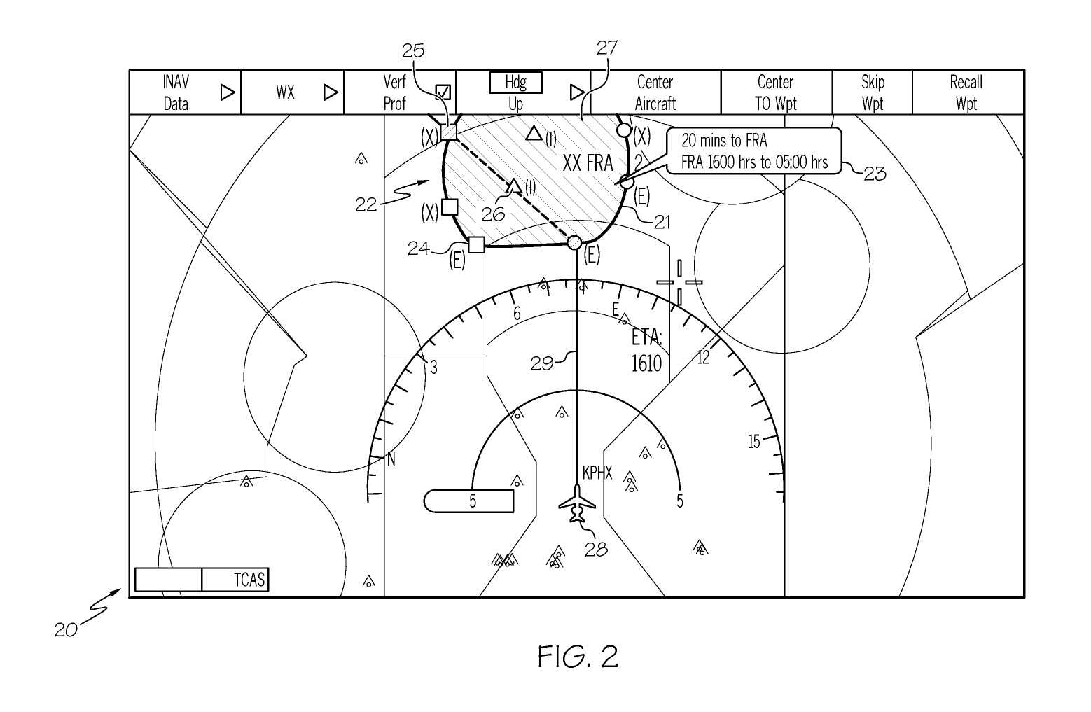

An example real-time representation 20 to be displayed on the display 18 is shown in FIG. 2. As can be seen in FIG. 2, the real-time representation 20 includes a visual representation 22 of a free route airspace location. In exemplary embodiments, the visual representation 22 of the free route airspace location includes a bounded area on a simulated map graphic, the bounded area indicating the location of the free route airspace location with respect to geographical features (not shown) of the local area. In exemplary embodiments, the visual representation 22 of the free route airspace location further includes a representation of one or more established entry points 24 and a representation of one or more established exit points 25. In exemplary embodiments, the visual representation 22 of the free route airspace location also includes a representation of one or more intermediate waypoints 26. In exemplary embodiments, the visual representation only displays a single established entry point 24, a single established exit point 25 and one or more intermediate waypoints 26 that lie along the pre-determined flight plan stored in the memory module 12. In exemplary embodiments, the real-time representation 20 shows established entry points 24 and established exit points 25 available for other aircraft.

In exemplary embodiments, the real-time representation 20 includes a visual icon 28 of the aircraft's current location with respect to the free route airspace (FRA) location representation 22. In exemplary embodiments, the real-time representation 20 also includes a representation of the aircraft's stored flight plan 29.

In the real-time representation 20 shown in FIG. 2, the displayed free route airspace location is presently not available for free routing. As such, a visual indication 27 is displayed to the pilot that the free route airspace location is presently outside of the associated time window of availability for free routing. In an exemplary embodiment, the visual indication 27 may include cross-hatching or a “greying-out” of the area within a boundary line 21 indicating the extent of the free route airspace location. As can be seen in FIG. 2, the present time, according to the system clock, is not inside the time window of availability for free routing within the free route airspace location. As such, no free routing can presently be performed in the free route airspace, and the visual representation 22 inside the boundary line 21 is cross-hatched to indicate to the pilot that aircraft in the free route airspace location must adhere to fixed routing.

In exemplary embodiments, if the time window of availability of the free route airspace location is temporally close to the present time, an update indication 23 may be displayed to the pilot to indicate that the free route airspace will soon become available for free routing. For example, in the real-time representation shown in FIG. 2, an estimated time of arrival of the aircraft at the free route airspace location is 1610 hrs. The present time according to the system clock is 1550 hrs. In exemplary embodiments, the estimated time of arrival is obtained based on aircraft parameters obtained from the positioning module 19. Information from the memory module 12 indicates that the time window of availability for free routing of aircraft in the free route airspace location is from 1600 hrs to 0500 hrs. As such, an update indication 23 is displayed to the pilot to indicate to the pilot that the time window of availability of the free route airspace location will change from unavailable to available when the aircraft reaches the free route airspace location, thereby notifying the pilot that free routing may be implemented when the aircraft reaches the free route airspace location. In an exemplary embodiment, the update indication 23 also indicates to the pilot an estimated time before the aircraft enters the free route airspace location (for example, 20 minutes). In an exemplary embodiment, the update indication 23 is also provided audibly to the pilot via the speaker 13 as well as being displayed to the pilot, for additional assurance that the pilot is notified of the update indication 23.

In exemplary embodiments, the processing module 14 is configured to compare the estimated time of arrival of the aircraft at the free route airspace location to the time window of availability of the free route airspace location. If the estimated time of arrival of the aircraft at the free route airspace location falls within the time window of availability of free routing within the free route airspace location, the update indication 23 is provided to the pilot. In exemplary embodiments, if the estimated time of arrival at the free route airspace location falls within a predetermined time period from a future change in the time window of availability of the free route airspace location, for example within about an hour of a future change to the time window of availability of free routing within the free route airspace location, the update indication 23 is provided to the pilot. By providing the update indication 23 to the pilot when the estimated time of arrival at the free route airspace location falls within a predetermined time period from the time window of availability of the free route airspace location, the pilot is notified of issues relating to free routing of other aircraft in the same airspace as the aircraft. In particular, the update indication 23 provided to the pilot could prompt the pilot to be aware of additional conflicts that may occur due to other aircraft free routing in the same airspace as the aircraft.

In exemplary embodiments, the processing module 14 is configured to compare the estimated time of arrival at the free route airspace location to the time window of availability for free routing of the free route airspace location and also to an estimated time of arrival according to a stored flight plan. The stored flight plan may have been created assuming that the aircraft would arrive at the free route airspace location within a time window of availability for free routing within the free route airspace location. However, if the aircraft is delayed and it is estimated that the aircraft will not arrive at the free route airspace location within the time window of availability for free routing within the free route airspace location, the update indication 23 indicates to the pilot that the originally planned flight plan (which contained a free routing section) is no longer viable and the aircraft must travel along a fixed route instead.

In exemplary embodiments, the update indication 23 also indicates to the pilot the difference in fuel consumption between an originally planned route and an updated route. For example, if a section of the stored flight plan that was originally intended to be a free route section is updated to a fixed route section, the update indication 23 indicates to the pilot an estimate of the additional amount of fuel the extra distance travelled on the fixed route section will use.

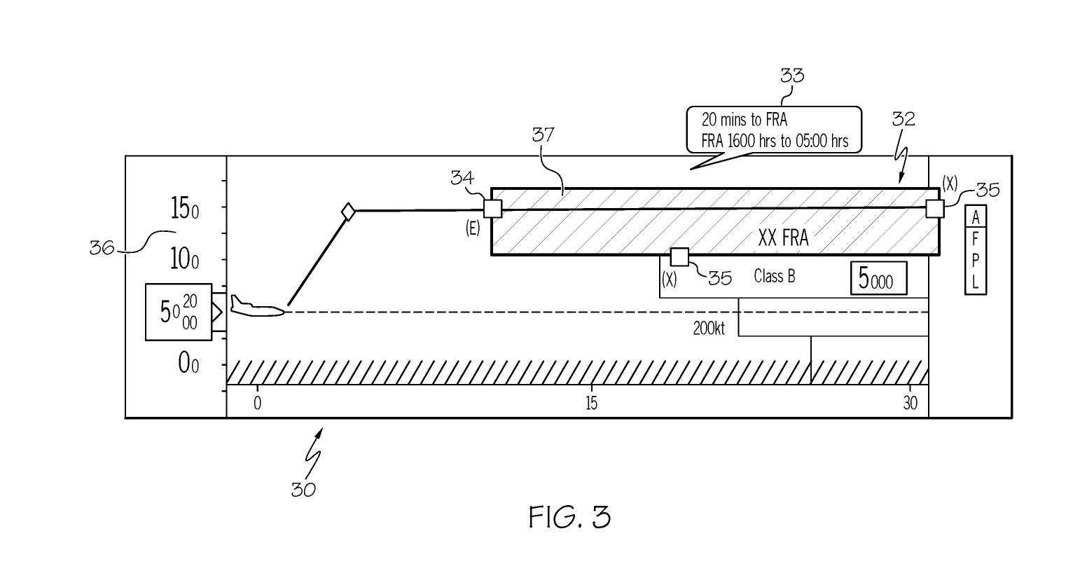

Referring now to FIG. 3, another example real-time representation 30 according to various embodiments is shown. The real-time representation 30 may be displayed on the display 18 in addition to, or as an alternative to, the real-time representation 20 shown in FIG. 2. In the real-time representation 30, the visual representation 32 of the free route airspace location is shown with respect to an altimeter 36, thereby providing more information to the pilot regarding the parameters of the free route airspace location, for example the altitudes of the boundary of the free route airspace location.

In the display of FIG. 3, further information about the established entry points 34 and established exit points 35 of the free route airspace location is also displayed to the pilot. In particular, in the real-time representation 30, the altitude of the established entry points 34 and exit points 35 is displayed to the pilot with respect to the altimeter 36. In exemplary embodiments information about established entry points 34 and established exit points 35 to and from free route airspace locations available to other aircraft is displayed on the real-time representation 30.

The situation shown in the real-time representation 30 of FIG. 3 is the same situation shown in the real-time representation of FIG. 2, i.e., the estimated time of arrival of the aircraft at the free route airspace (FRA) location is 1610 hrs, and the time window of availability of the free route airspace location is 1600 hrs to 0500 hrs. The present time according to the system clock 11 is 1550 hrs. As such, a visual indication 37 is provided to the pilot that the free route airspace location is presently not available for free routing of aircraft. The visual indication 37 may include cross-hatching, or another visual indicator, in the area of the visual representation 32 of the free route airspace location.

In exemplary embodiments, an update indication 33 is provided to the pilot to indicate that the time window of availability for free routing of the free route airspace location is from 1600 hrs to 0500 hrs, and that it is estimated that the aircraft is 20 minutes away from entering the free route airspace location. Due to the update indication 33, the pilot is thereby notified that, although the time window availability for free routing of the free route airspace location is presently closed, the time window availability for free routing will be available when the aircraft reaches the free route airspace location.

The real-time representation 30 may display additional information to the pilot, to further increase the pilot's situational awareness. For example, as shown in FIG. 3, the real-time representation may show airspace classification schemes (such as class B airspace) of the airspace surrounding the free route airspace location to the pilot together with the free route airspace location altitude, so that the pilot is further aware of the parameters of the boundary of the free route airspace location, and whether the airspace around the free route airspace location is busy. For example, when an established exit point is located in or close to a Class B airspace (which classification is used to define busy, key airport traffic areas), the pilot may determine that conflicts with other aircraft are more likely after exiting the free route airspace location at an established exit point 35.

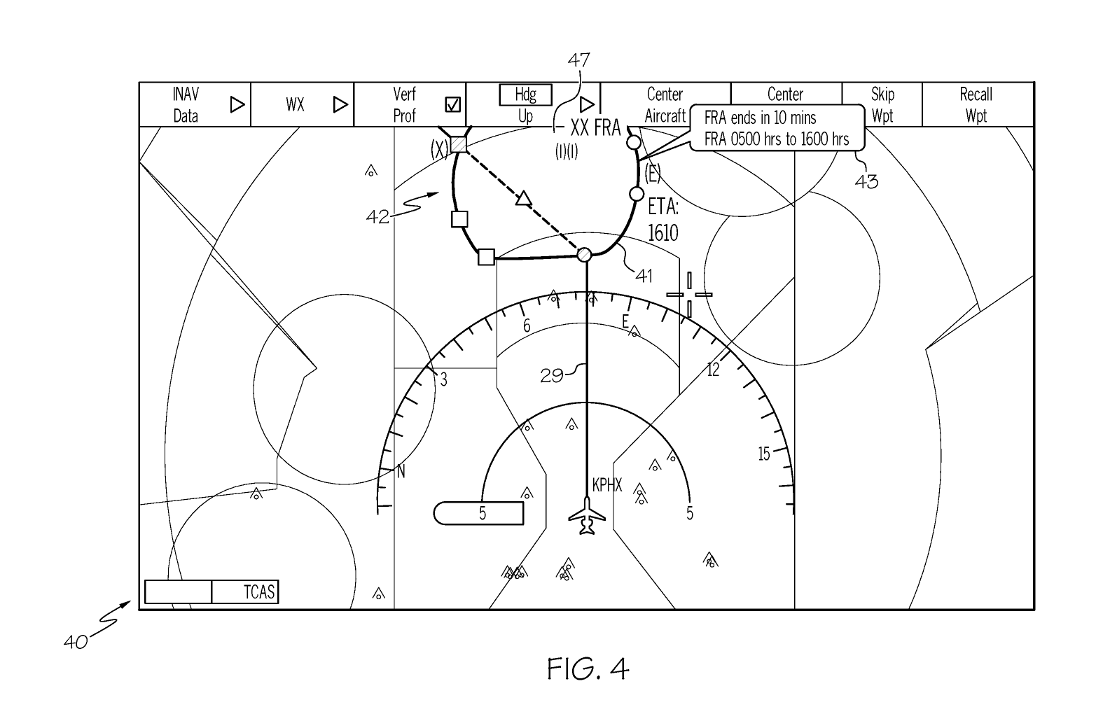

Referring now to FIG. 4, a real-time representation 40 is shown in which the availability time window for free route planning of aircraft within the free route airspace location is close to ending. In the situation depicted, the present time according to the system clock is 1550 hrs, and the time window of availability for free route planning of the free route airspace location ends in around 10 minutes, at 1600 hrs. The positioning module 19 determines that the aircraft is around 20 minutes away from arriving at the free route airspace location. As such, the processing module 14 determines that the time window for free route planning of aircraft in the free route airspace location will close before the aircraft arrives at the free route airspace location.

Since the free route airspace location is presently available for free route planning, a visual indication 47 of a visual representation 42 of the free route airspace location indicates that free route planning may presently occur. In an exemplary embodiment, the visual indication 47 indicating that free route planning may presently occur in the free route airspace location is the lack of cross-hatching within a boundary line 41 of the visual representation 42. In exemplary embodiments, other types of visual indication 47 are used, for example highlighted sections or different colors.

An update indication 43 is provided to the pilot indicating that the time window of availability for free route planning of aircraft within the free route airspace location is about to close. If the flight plan of the aircraft originally incorporated a freely planned route through the free route airspace location, the pilot is therefore notified that this freely planned route is no longer available, and therefore the aircraft must travel along a fixed route instead when the aircraft reaches the free route aircraft location.

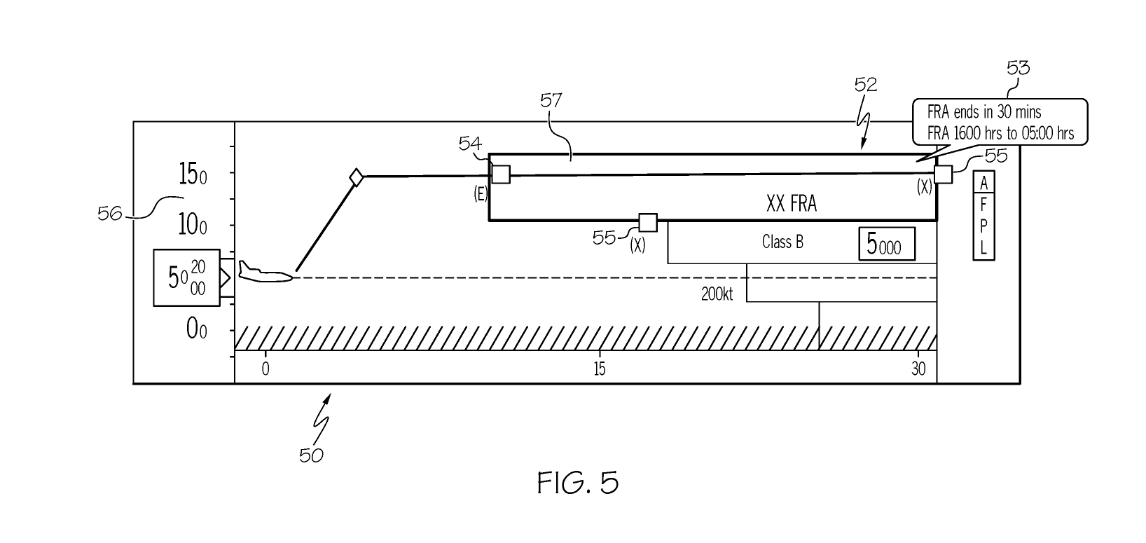

Referring now to FIG. 5, another example real-time representation 50 according to various embodiments is shown. In a similar manner to the real-time representation of FIG. 2, the real-time representation 50 may be displayed on the display 18 in addition to, or as an alternative to, the real-time representation 40 shown in FIG. 4. In the real-time representation 50, the visual representation 52 of the free route airspace location is shown with respect to an altimeter 56, thereby providing more information to the pilot regarding the parameters of the free route airspace location.

In the real-time representation of FIG. 5, further information about the established entry points 54 and established exit points 55 of the free route airspace location is also displayed to the pilot. In particular, in the real-time representation 50, the altitude of established entry points 54 and exit points 55 is displayed to the pilot with respect to the altimeter 56. In exemplary embodiments information about established entry points 54 and established exit points 55 to and from free route airspace locations available to other aircraft is displayed on the real-time representation 50.

The situation shown in the real-time representation 50 of FIG. 5 is the same situation shown in the real-time representation of FIG. 4, i.e., the estimated time of arrival of the aircraft at the free route airspace (FRA) location is 1610 hrs, and the time window of availability of the free route airspace location is 0500 hrs to 1600 hrs. The present time according to the system clock 11 is 1550 hrs. As such, a visual indication 57 is provided to the pilot that the free route airspace location is presently available for free routing. As explained above, the visual indication 57 may include the lack of cross-hatching in the area of the visual representation 52 of the free route airspace location. The visual representation 52 of the free route airspace location is shown adjacent to an altimeter 56.

In exemplary embodiments, an update indication 53 is provided to the pilot to indicate that the time window of availability for free routing of the free route airspace location is from 0500 hrs to 1600 hrs, and that it is estimated that the aircraft is 20 minutes away from entering the free route airspace location. Due to the update indication 53, the pilot is notified that, although the time window availability for free routing of the free route airspace location is presently open, the time window availability for free routing will be closed when the aircraft reaches the free route airspace location. As such, if the flight plan of the aircraft originally included a freely planned route component in the free route airspace location, the pilot is notified that the freely planned route is no longer available, and the aircraft must travel along a fixed route.

In exemplary embodiments, the update indications provided to the pilot may contain additional information, for example information about temporary flight restrictions, such as temporarily restricted airspace locations. In exemplary embodiments, the navigation system 10 further includes a receiver (not shown) for receiving temporary flight restriction information. The processing module 14 is configured to include such additional information into the update indications provided to the pilot. In an exemplary embodiment, the additional information may include a notice from ATC that no free routing is allowed within a free route airspace location, despite the free route airspace location presently being within the time window of availability for free routing.

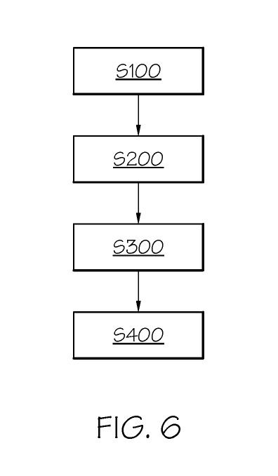

Turning to FIG. 6, a method for displaying an availability for free routing within at least one free route airspace location to a pilot is shown. At step S100, information related to at least one free route airspace location along a flight plan of the aircraft and an associated time window of availability for free routing within the at least one free route airspace locations is stored in a memory module. At step S200, a comparison is made between a stored time window of availability for free routing within the at least one free route airspace location and a system clock time. At step S300, a determination is made, on the basis of the comparison, regarding the present availability for free routing within the at least one free route airspace location. At step S400, the present availability for free routing within the at least one free route airspace location is displayed to the pilot.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A navigation system for use in an aircraft, the navigation system comprising:
a display;
a memory module configured to store information related to at least one free route airspace location along a flight plan of the aircraft and an associated time window of availability for free routing of aircraft within the at least one free route airspace location; and
a processing module operably connected to the display and to the memory module, wherein the processing module is configured to receive the information related to the at least one free route airspace location and associated time window of availability for free routing of aircraft within the at least one free route airspace location from the memory module and to cause the display to display a real-time representation of an availability of free routing of aircraft within the at least one free route airspace location.

2. The navigation system of claim 1, wherein the processing module is further configured to display an update indication comprising information about a future change in the availability of free routing of aircraft within the at least one free route airspace location.

3. The navigation system of claim 2, wherein the information in the update indication includes a notification that the associated time window of availability for free routing of aircraft within the at least one free route airspace location will change from open to closed before an estimated time of arrival of the aircraft at the at least one free route airspace location.

4. The navigation system of claim 2, wherein the information in the update indication includes a notification that the associated time window of availability for free routing of aircraft within the at least one free route airspace location will change from closed to open before an estimated time of arrival of the aircraft at the at least one free route airspace location.

5. The navigation system of claim 2, wherein the information in the updated indication includes a notification that the flight plan of the aircraft needs to be changed as a result of a change in the associated time window of availability for free routing of aircraft within the at least one free route airspace location.

6. The navigation system of claim 2, wherein the information in the updated indication includes information about a change in fuel consumption associated with the future change in the availability of free routing of aircraft within the at least one free route airspace location.

7. The navigation system of claim 1, wherein the real-time representation further comprises a location of established entry and exit gates to and from the at least one free route airspace location.

8. The navigation system of claim 7, wherein the established entry and exit gates to and from the at least one free route airspace location comprise established entry and exit gates available to the aircraft.

9. The navigation system of claim 7, wherein the established entry and exit gates to and from the at least one free route airspace location comprise established entry and exit gates available to other aircraft.

10. The navigation system of claim 1, wherein the real-time representation further comprises altitude information associated with the at least one free route airspace location.

11. A method of displaying an availability for free routing within at least one free route airspace location to a pilot, comprising:
storing information related to at least one free route airspace location along a flight plan of the aircraft and an associated time window of availability for free routing of aircraft within the at least one free route airspace locations in a memory module;
comparing the stored time window of availability for free routing of aircraft within the at least one free route airspace location to a system clock time;
determining, on the basis of the comparison, the present availability for free routing of aircraft within the at least one free route airspace location; and
displaying the present availability for free routing of aircraft within the at least one free route airspace location to the pilot.

12. The method of claim 11, wherein the step of displaying present availability for free routing of aircraft within the at least one free route airspace location to the pilot further comprises displaying to the pilot an update indication containing information about a future change in the availability of free routing within the at least one free route airspace location.

13. The method of claim 12, wherein the information in the update indication includes a notification that the associated time window of availability for free routing of aircraft within the at least one free route airspace location will change from open to closed before an estimated time of arrival of the aircraft at the at least one free route airspace location.

14. The method of claim 12, wherein the information in the update indication includes a notification that the associated time window of availability for free routing of aircraft within the at least one free route airspace location will change from closed to open before an estimated time of arrival of the aircraft at the at least one free route airspace location.

15. The method of claim 12, wherein the information in the update indication includes a notification that the flight plan of the aircraft needs to be changed as a result of a change in the associated time window of availability for free routing of aircraft within the at least one free route airspace location.

16. The method of claim 12, wherein the information in the update indication includes information about a change in fuel consumption associated with the future change in the availability of free routing of aircraft within the at least one free route airspace location.

17. The method of claim 11, wherein the step of displaying present availability for free routing of aircraft within the at least one free route airspace location to the pilot further comprises displaying to the pilot a location of established entry and exit gates to and from the at least one free route airspace location.

18. The method of claim 17, wherein the established entry and exit gates to and from the at least one free route airspace location comprise established entry and exit gates available to the aircraft.

19. The method of claim 17, wherein the established entry and exit gates to and from the at least one free route airspace location comprise established entry and exit gates available to other aircraft.

20. The method of claim 11, wherein the step of displaying present availability for free routing of aircraft within the at least one free route airspace location to the pilot further comprises displaying to the pilot altitude information about the at least one free route airspace location.
